(19) United States
(12) Patent Application Publication
(10) Pub. No.: US 2018/0143903 A1
(43) Pub. Date: May 24, 2018

(54) HARDWARE ASSISTED CACHE FLUSHING MECHANISM

(71) Applicant: MediaTek Inc., Hsinchu (TW)

(72) Inventors: Ming-Ju Wu, Hsinchu (TW); Chien-Hung Lin, Hsinchu (TW); Chia-Hao Hsu, Changhua County (TW); Pi-Cheng Hsiao, Taichung (TW); Shao-Yu Wang, Hsinchu (TW)

(21) Appl. No.: 15/620,794

(22) Filed: Jun. 12, 2017

Related U.S. Application Data
(60) Provisional application No. 62/425,168, filed on Nov. 22, 2016.

(51) Int. Cl. G06F 12/0804; G06F 12/0815; G06F 12/121

(52) U.S. Cl. CPC G06F 12/0804; G06F 12/0815; G06F 2212/69; G06F 2212/60; G06F 2212/621; G06F 12/121

(57) ABSTRACT

A multi-cluster, multi-processor computing system performs a cache flushing method. The method begins with a cache maintenance hardware engine receiving a request from a processor to flush cache contents to a memory. In response, the cache maintenance hardware engine generates commands to flush the cache contents to thereby remove workload of generating the commands from the processors. The commands are issued to the clusters, with each command specifying a physical address that identifies a cache line to be flushed.

### CROSS-REFERENCE TO RELATED APPLICATIONS

This application claims the benefit of U.S. Provisional Application No. 62/425,168 filed on Nov. 22, 2016.

### TECHNICAL FIELD

Embodiments of the invention relate to memory management in a computing system; and more specifically, to a cache flushing mechanism in a multi-processor computing system.

### BACKGROUND

In a multi-processor computing system, each processor has its own cache to store a copy of data that is also stored in the system memory. A cache is a smaller, faster memory than the system memory, and is generally located on the same chip as the processors. Caches enhance system performance by reducing off-chip memory accesses. Most processors have independent caches for instruction and data. The data cache is usually organized as a hierarchy of multiple levels, with smaller and faster caches backed up by larger and slower caches. In general, multi-level caches are accessed by checking the fastest, level-1 (L1) cache first; if there is a miss in L1, then the next fastest level-2 (L2) cache is checked, and so on, before the off-chip system memory is accessed.

One of the commonly used cache maintenance policies is called the “write-back” policy. With the write-back policy, a processor updates a data item only in its local cache. The write to the system memory is postponed until the cache line containing the data item is about to be replaced by another cache line. Before the write-back operation, the cache content may be newer and inconsistent with the system memory content which holds the old data. Data coherency between the cache and system memory can be achieved by flushing (i.e., writing back) the cache content into the system memory.

In addition to cache line replacement, a cache line may be written back to the system memory in response to cache flushing commands. Cache flushing may be needed when a block of data is required by a direct-memory access (DMA) device, such as when a multimedia application that runs on a video processor wants to read the latest data from the system memory. However, the application needing the memory data may need to wait until the cache flushing operation completes. Thus, the latency caused by cache flushing is critical to user experiences. Therefore, there is a need for improving the performance of cache flushing.

### SUMMARY

In one embodiment, a method is provided for flushing cache contents in a computing system. The computing system includes a plurality of clusters, with each cluster includes a plurality of processors. The method comprises: receiving a request from a processor by a cache maintenance hardware engine to flush the cache contents to a memory; generating, by the cache maintenance hardware engine, commands to flush the cache contents to thereby remove workload of generating the commands from the processors; and issuing the commands to the clusters, with each command specifying a physical address that identifies a cache line to be flushed.

In one embodiment, a system that performs cache flushing is provided. The system comprises: a plurality of clusters, each cluster includes a plurality of processors and a plurality of caches; a memory coupled to the clusters via a cache coherence interconnect; and a cache maintenance hardware engine. The cache maintenance hardware engine is operative to: receive a request from one of the processors to flush the cache contents to the memory; generate commands to flush the cache contents to thereby remove workload of generating the commands from the processors; and issue the commands or cause the command to be issued to the clusters, with each command specifying a physical address that identifies a cache line to be flushed.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a block diagram of a multi-processor computing system according to one embodiment.

FIG. 2 is a flow diagram illustrating a method of a cache maintenance engine for flushing cache contents according to one embodiment.

FIG. 3 illustrates a block diagram of a multi-processor computing system that includes a snoop filter according to one embodiment.

FIG. 4 is a flow diagram illustrating a method for flushing cache contents using the information provided by a snoop filter according to one embodiment.

FIGS. 5A, 5B and 5C are diagrams illustrating examples of using a snoop filter for flushing cache contents according to some embodiments.

FIG. 6 is a flow diagram illustrating a method for a whole system flush according to one embodiment.

FIG. 7 is a flow diagram illustrating a method of a computing system for flushing cache contents according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

It should be noted that the “multi-processor computing system” as described herein is a “multi-core processor system.” In one embodiment, each processor may contain one or more cores. In an alternative embodiment, each processor may be equivalent to a core. The processors described herein may contain a combination of central processing units (CPUs), a graphics processing units (GPUs), digital signal processors (DSPs), multimedia processors, and any processors that have access to the system memory. A cluster may be implemented as a group of one or more processors.

It should also be noted that the term “cache flushing” herein refers to writing dirty (i.e., modified) cache data entries to the system memory. The “system memory” herein is equivalent to the main memory, such as the dynamic random access memory (DRAM) or other volatile or non-volatile memory devices. The cache data entries after being written back to the system memory may be marked invalidated or shared, depending on the system implementations. A cache line refers to a fixed-size data block in a cache, which is a basic unit for data transfer between the system memory and the caches. In one embodiment, the system memory physical address may include a first part and a second part. A cache line can be identified by the first part of the system memory physical address. The second part of the system memory physical address (also referred to as an offset) may identify a data byte within a cache line. In the following, the term “physical address” in connection with cache maintenance operations refers to the first part of the system memory physical address. The numbers of bits in the first part and the second part of the system memory physical address may vary from one system to another.

Embodiments of the invention provide a cache maintenance hardware engine (also referred to as a cache maintenance (CM) engine) for efficiently flushing cache contents into a system memory. The CM engine is a dedicated hardware unit for performing cache maintenance operations, including generating commands to flush cache contents. When a processor or an application running on a processor determines to flush cache contents, the processor sends a request to the CM engine. In response to the request, the CM engine generates commands to flush the cache contents, one cache line at a time, such that the workload of generating the commands is removed from the processors. The processor's request may indicate a range of physical addresses to be flushed from the caches, or indicate that all of the caches to be completely flushed. While the CM engine generates the commands, the processor may continue to perform useful tasks without waiting for the commands to be generated and issued.

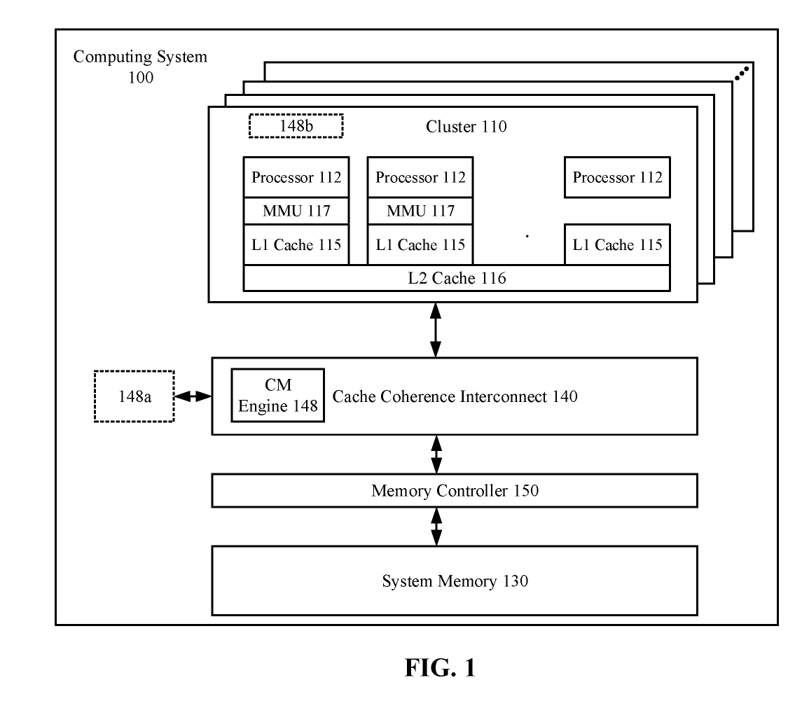

FIG. 1 illustrates an example architecture of a multi-processor computing system 100 according to one embodiment. The computing system 100 includes one or more clusters 110, and each cluster 110 further includes one or more processors 112. Each cluster 110 has access to a system memory 130 via a cache coherence interconnect (CCI) 140 and a memory controller 150. In some embodiments, different clusters 110 may have different types of processors 112. In one embodiment, the communication links between the CCI 140 and the memory controller 150, as well as between the memory controller 150 and the system memory 130, use a high performance, high clock frequency protocol; e.g., the Advanced eXtensible Interface (AXI) protocol. In one embodiment, all of the clusters 110 communicate with the CCI 140 using a protocol that supports system wide coherency; e.g., the AXI Coherency Extensions (ACE) protocol. It is understood that the AXI and the ACE protocols are non-limiting examples; different protocols may be used in different embodiments. It is also understood that many hardware components are omitted herein for ease of illustration, and the computing system 100 may include any number of clusters 110 with any number of processors 112.

In one embodiment, the computing system 100 may be part of a mobile computing and/or communication device (e.g., a smartphone, a smart watch, a tablet, laptop, etc.). In one embodiment, the computing system 100 may be a computer, an appliance, a server, or a part of a cloud computing system.

FIG. 1 also shows that each processor 112 may have access to multiple levels of caches. For example, each processor 112 has its own level-1 (L1) cache 115, and each cluster 110 includes a level-2 (L2) cache 116 shared by the processors 112 in the same cluster 110. Although two levels of caches are shown, in some embodiments the computing system 100 may have more than two levels of cache hierarchy. For example, each of the L1 cache 115 and the L2 cache 116 may further include multiple cache levels. In some embodiments, different clusters 110 may have different numbers of cache levels.

In one embodiment, the L1 caches 115 and the L2 cache 116 of each cluster 110 use physical addresses as indexes to the stored cache contents. However, applications that run on the processors 112 typically use virtual addresses to reference data locations. In one embodiment, a request from an application that specifies a virtual address range for cache flushing is first translated to a physical address range. The processor 112 on which the application runs then sends a cache flushing request to a CM engine 148 specifying the physical address range.

Various known techniques may be used to translate virtual addresses to physical addresses. In one embodiment, each processor 112 includes or is coupled to a memory management unit (MMU) 117, which is responsible for translating virtual addresses to physical addresses. The MMU 117 may include or otherwise use one or more translation look-aside buffers (TLB) to store a mapping between virtual addresses and their corresponding physical addresses. The TLB stores a few entries of a page table containing those address translations that are most likely to be referenced (e.g., most-recently used translations or translations that are stored based on a replacement policy). In one embodiment, each of the caches 115 and 116 may be associated with a TLB that stores the address translations that are most likely to be used by that cache. If an address translation cannot be found in the TLBs, a miss address signal may be sent to the memory controller 150 through the cache coherence interconnect 140, which retrieves the page table data containing the requested address translation either from the system memory 130 or elsewhere in the computing system 100.

After the processor 112 obtains the physical address range (by address translation or other means) for cache flushing, the processor 112 sends a cache flushing request to the CM engine 148 specifying the physical address range. In one embodiment, the CM engine 148 may be part of the CCI 140, as represented by a solid box labeled 148. FIG. 1 also shows alternative locations in which the CM engine 148 may reside. In a first alternative embodiment, a CM engine 148a may be outside of and coupled to the CCI 140; e.g., the CM engine 148a may be a cache coherent interface master represented by a dotted box labeled 148a. In the first alternative embodiment, the CM engine 148a may connect to the CCI 140 via the same interface protocol, or a variation of the interface protocol used by the processors 112; e.g., the ACE or ACE-lite protocol. In a second alternative embodiment, a CM engine 148b may be within a cluster 110 and coupled to one or more of the processors 112 in that cluster 110, e.g., the CM engine 148b may be a co-processor represented by a dotted box labeled 148b. For ease of description, in the following the term “CM engine 148” is used; however, it is understood that the CM engine 148, or a hardware unit performing the operations of the CM engine 148 (such as the CM engine 148a or 148b), may be located in another location within the computing system 100 of FIG. 1. It is understood that the examples shown in FIG. 1 are illustrative and non-limiting.

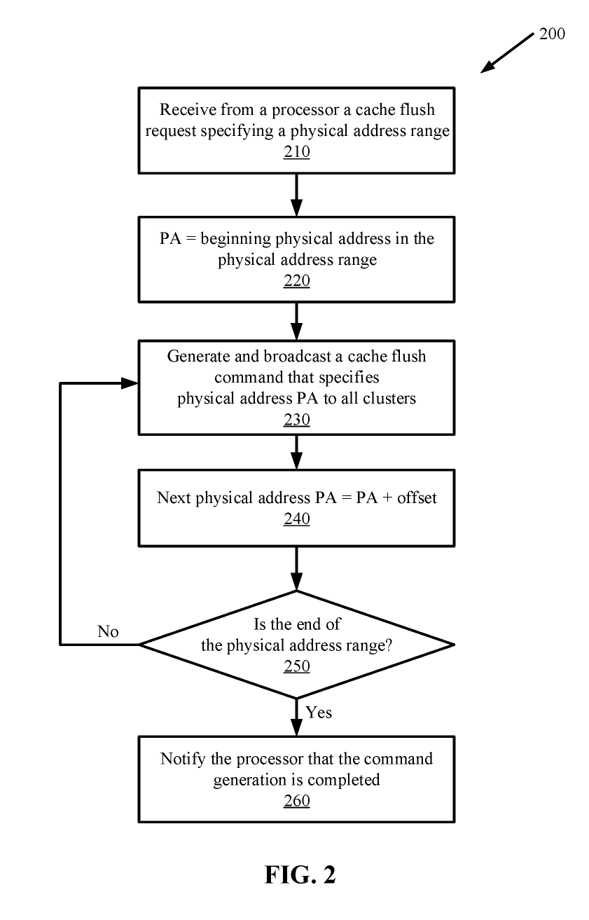

After the CM engine 148 receives a cache flushing request that specifies a physical address range, the CM engine 148 generates a series of commands with each command specifying one physical address in the physical address range. FIG. 2 is a flow diagram illustrating a method 200 for generating cache flushing commands according to one embodiment. In one embodiment, the method 400 may be performed by the computing system 100 of FIG. 1; more specifically, by the CM engine 148 of FIG. 1.

The method 200 begins at step 210 with the CM engine 148 receiving a cache flushing request from a processor specifying a physical address range. The CM engine 148 steps through the physical address range to generate cache flushing commands. More specifically, at step 220, a loop is initialized with a loop index PA=the beginning address in the physical address range. At step 230, the CM engine 148 generates and broadcasts a cache flush command that specifies the physical address PA to all clusters. The loop index PA increments at step 240 by an offset (where offset=the size of a cache line) to the next physical address, and the CM engine 148 repeats step 230 to generate and broadcast a cache flush command specifying the physical address PA. The method 200 repeats steps 230 and 240 until at step 250 the end of the physical address range is reached. In one embodiment, the CM engine 148 may notify the processor or the application which initiated the cache flushing request to indicate that the generation of cache flushing commands is completed at step 260.

In some scenarios, a processor may request to flush a physical address range, but some of the physical addresses in the range may not be in any cache. It is unnecessary, and a waste of time and system resources, to generate a cache flushing command that specifies a physical address not in any cache of the computing system. In some embodiments, a computing system may use a mechanism for tracking which data entries are cached, in which cluster or clusters a data entry is cached, and the state of each cache data entry. An example of such a mechanism is called snooping. For multi-processor systems with shared memory, snooping-based hardware cache coherence is widely adopted. If a processor's local cache access results in a miss, the processor can snoop other processors' local caches to determine whether those processors have the most up-to-date data. The majority of snooping requests, however, may result in a miss response, because most applications have few shared data. A snoop filter is a hardware unit in the CCI 140 (FIG. 1) that helps to eliminate these redundant snoops among the processors.

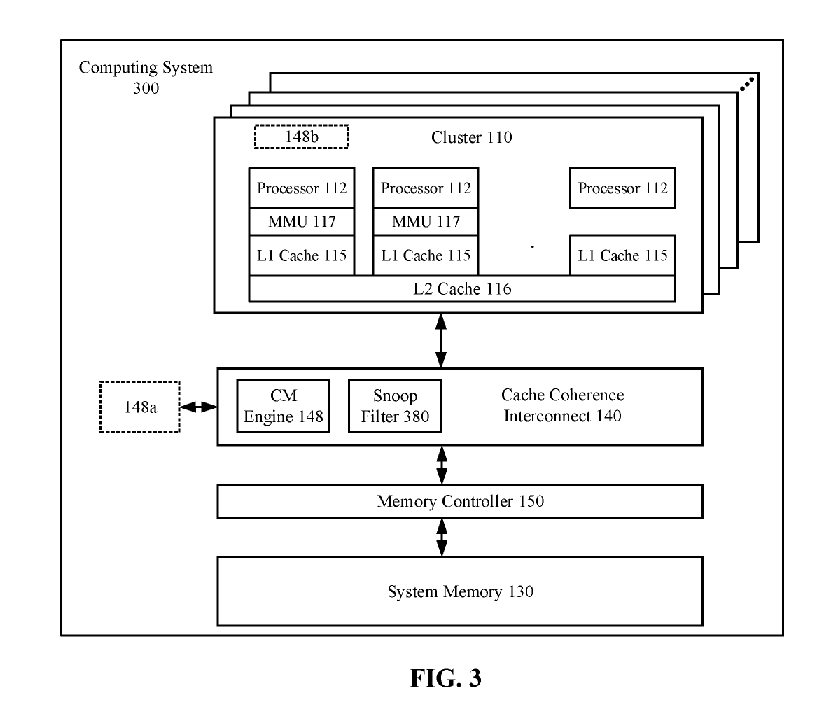

FIG. 3 illustrates an example architecture of a multi-processor computing system 300 according to another embodiment. The multi-processor computing system 300 may include the same components as shown in the embodiment of FIG. 1, and additionally includes a snoop filter 380 in the CCI 140. The snoop filter 380 records the states of all cache lines in the computing system 300. In one embodiment, the state of a cache line may indicate whether the cache line has been modified, has one or more valid copies outside the system memory, has been invalidated, and the like. When a processor 112 encounters a miss for a requested cache line in its local cache, the processor 112 can request the CCI 140 to look up the snoop filter 380 to determine whether any other caches in the computing system 300 have that requested cache line. Snooping requests among the processors can be eliminated if the snoop filter 380 indicates that the other caches do not have the requested cache line. If another cache has the requested cache line, the snoop filter 380 may further indicate which cluster or clusters hold the most up-to-date copy of the requested cache line.

In one embodiment, the snoop filter 380 stores a physical address of a cache line to indicate the presence of that cache line in one or more of the clusters 110. Moreover, given a physical address of a data entry, the snoop filter 380 can identify one or more clusters in the computing system 300 that hold a copy of the data entry in their caches.

In one embodiment, the CM engine 148 may use the snoop filter 380 to filter its cache flushing commands, such that all commands issued to the clusters 110 result in hits; i.e., all of the filtered commands are directed to cache lines that exist in at least one cluster 110. Thus, if a cache flushing command specifies a physical address that is not in the snoop filter 380, the command is not issued to any cluster 110.

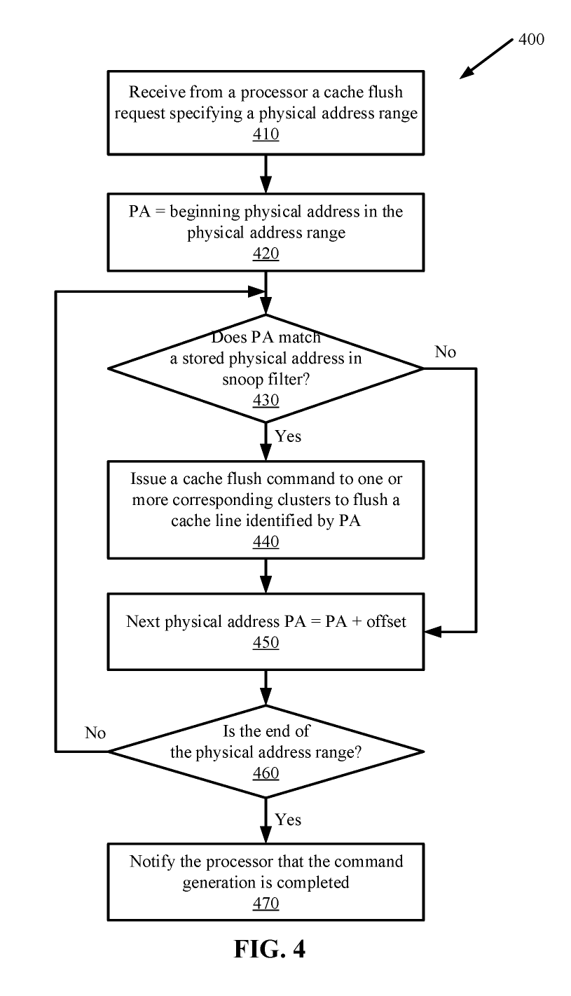

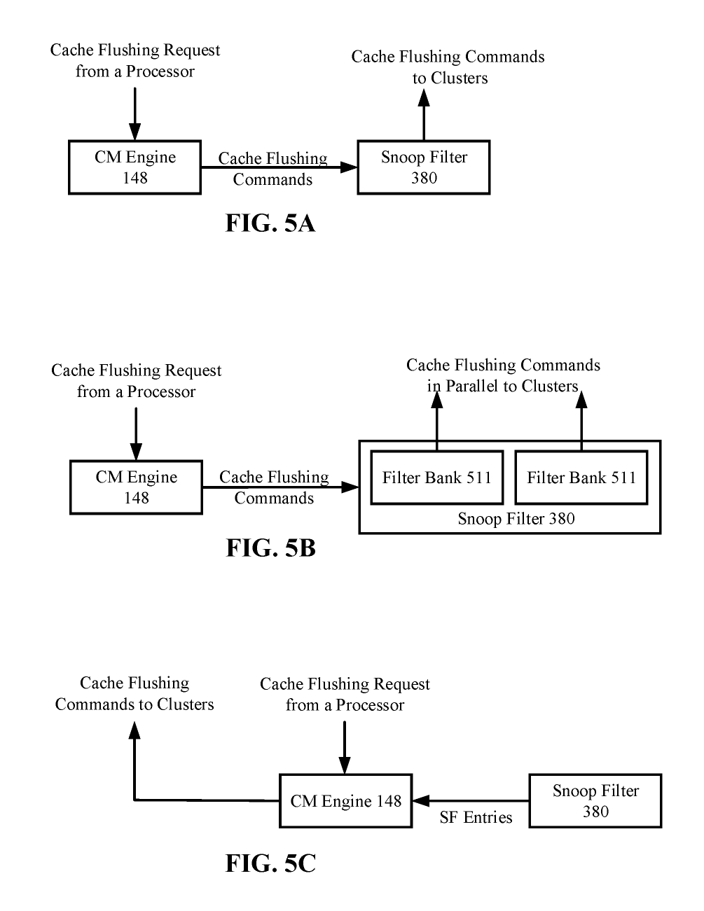

FIG. 4 is a flow diagram illustrating a method 400 for generating cache flush commands according to another embodiment. In one embodiment, the method 400 may be performed by the computing system 300 of FIG. 3. The method 400 begins at step 410 with the CM engine 148 receiving a cache flush request from a processor specifying a physical address range. The CM engine 148 steps through the physical address range to generate cache flushing commands. More specifically, at step 420, a loop is initialized with a loop index PA=the beginning address in the physical address range. It is determined at step 430 whether the physical address PA matches a stored physical address in the snoop filter 380; a match indicates that the data entry having the physical address PA is in a cache. Determining whether a physical address matches a stored physical address in the snoop filter 380 may include comparing the physical address with stored physical addresses in the snoop filter 380. The comparison may be made by the CM engine 148 or the snoop filter 380, as will be described in more detail with reference to FIGS. 5A-5C.

If the physical address PA matches a stored physical address in the snoop filter 380, at step 440 a cache flush command specifying the physical address PA is issued to the one or more corresponding clusters identified by the snoop filter 380. The loop index PA increments at step 450 by an offset (which is the size of a cache line) to the next physical address. The method 400 repeats the steps 440 and 450 until the end of the physical address range is reached at step 460. In one embodiment, the CM engine 148 may notify the processor or the application which initiated the cache flushing request to indicate that the generation of cache flushing commands is completed at step 470.

FIG. 5A illustrates an example of determining whether a given physical address is in the snoop filter 380. In this example, the CM engine 148 sends every cache flushing command that it generates to the snoop filter 380. When the CM engine 148 sends the commands to the snoop filter 380, the snoop filter 380 may forward only the commands that specify physical addresses stored in the snoop filter 380 to one or more corresponding clusters. That is, the snoop filter 380 forwards a command to one or more corresponding clusters if the given physical address specified by the command matches a stored physical address in the snoop filter 380. If the given physical address does not match any stored physical addresses in the snoop filter 380, the snoop filter 380 ignores the command.

FIG. 5B illustrates another example in which the snoop filter 380 includes two or more filter banks 511. Each filter bank 511 is responsible for tracking cache lines in a different portion of the physical address space of the system memory. For example, in the case of two filter banks 511, one filter bank 511 may be responsible for the even physical addresses, and other filter bank 511 may be responsible for the odd physical addresses. When the CM engine 148 sends the commands to the filter banks 511, the filter banks 511 may forward, in parallel, only the commands that specify physical addresses stored in the filter banks 511 to one or more corresponding clusters. That is, each filter bank 511 forwards a command to one or more corresponding clusters if the given physical address specified by the command matches a stored physical address in that filter bank 511. If a given physical address does not match any stored physical addresses in the filters bank 511, the filter banks 511 ignore the command.

FIG. 5C illustrates yet another example in which the CM engine 148 generates the commands only for those physical addresses matching stored physical addresses in the snoop filter 380. In one embodiment, the CM engine 148 may access the stored physical addresses (i.e., the SF entries) in the snoop filter 380, and compare the stored physical addresses with a requested physical address range to determine whether each stored physical address falls with the requested physical address range. This is helpful when the requested physical address range is large (e.g., greater than a threshold). In some cases, a processor 112 may send a request without an address range; e.g., when the processor 112 requests a whole system flush. That is, all of the accessible caches are to be flushed. In the case of a whole system flush, the CM engine 148 may generate commands specifying only those physical addresses stored in the snoop filter 380.

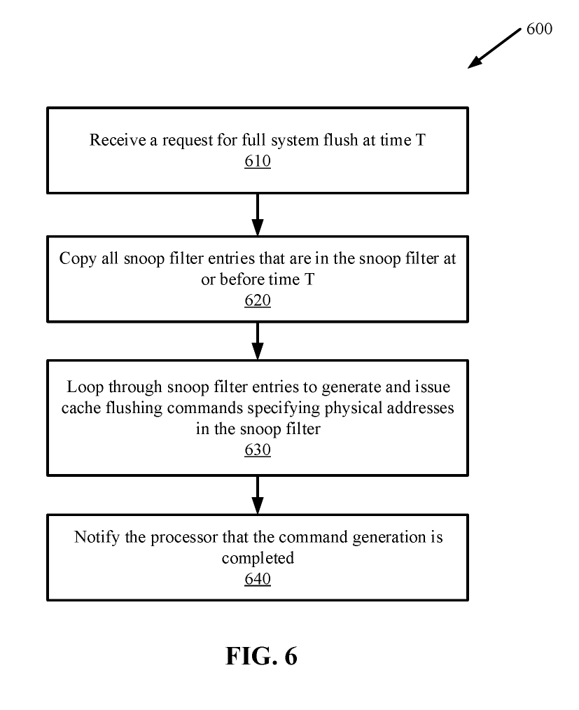

FIG. 6 is a flow diagram illustrating a method 600 for performing a whole system flush according to one embodiment. In one embodiment, the method 600 is performed by the CM engine 148 of FIG. 3. At step 610, the CM engine 148 receives a request for whole system flush at time T. In response, at step 620, the CM engine 148 may make a copy of all snoop filter entries that are in the snoop filter 380 at or before time T. Alternatively, the snoop filter 380 may stop updating at time T until the completion of the command generation, and the CM engine 148 may access the snoop filter 380 while it is generating cache flushing commands. The CM engine 148 at step 630 loops through the snoop filter entries to generate cache flushing commands specifying physical addresses that are in the snoop filter 380 at or before time T. The CM engine 148 then issues each generated command to the one or more corresponding clusters that hold the cache line identified by the physical address in the snoop filter 380. In one embodiment, the CM engine 148 may notify the processor or the application which initiated the cache flushing request to indicate that the generation of cache flushing commands is completed at step 640.

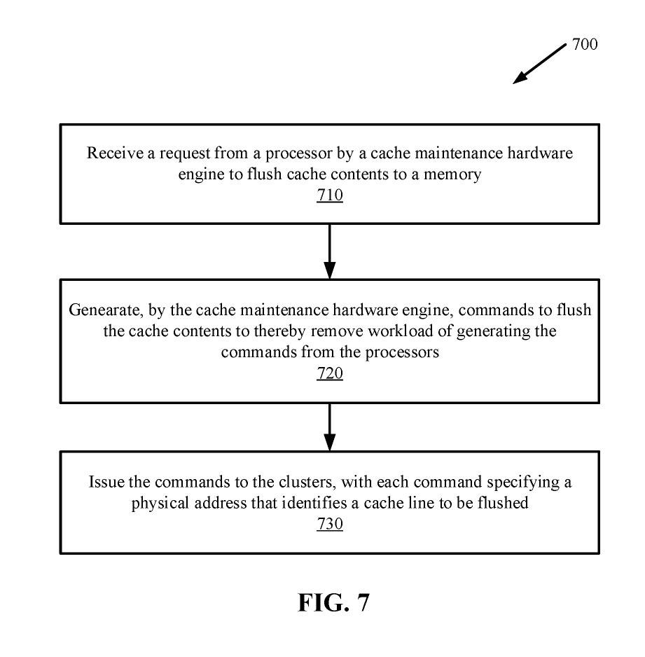

FIG. 7 is a flow diagram illustrating a method 700 for cache flushing in a computing system according to one embodiment. The computing system includes a plurality of clusters, with each cluster includes a plurality of processors; non-limiting examples of the computing system include the computing system 100 of FIG. 1 and the computing system 300 of FIG. 3. In one embodiment, the method 700 begins with a cache maintenance hardware engine (e.g., the CM engine 148 of FIG. 1 or FIG. 3) receiving a request from a processor to flush the cache contents to a memory (step 710). In response, the cache maintenance hardware engine generates commands to flush the cache contents to thereby remove workload of generating the commands from the processors (step 720). The commands are issued to the clusters, with each command specifying a physical address that identifies a cache line to be flushed (step 730).

The operations of the flow diagrams of FIGS. 2, 4, 6 and 7 have been described with reference to the exemplary embodiments of FIGS. 1 and 3. However, it should be understood that the operations of the flow diagrams of FIGS. 2, 4, 6 and 7 can be performed by embodiments of the invention other than those discussed with reference to FIGS. 1 and 3, and the embodiments discussed with reference to FIGS. 1 and 3 can perform operations different than those discussed with reference to the flow diagrams. While the flow diagrams of FIGS. 2, 4, 6 and 7 show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for flushing cache contents in a computing system that includes a plurality of clusters, with each cluster includes a plurality of processors, comprising:
receiving a request from a processor by a cache maintenance hardware engine to flush the cache contents to a memory;
generating, by the cache maintenance hardware engine, commands to flush the cache contents to thereby remove workload of generating the commands from the processors; and
issuing the commands to the clusters, with each command specifying a physical address that identifies a cache line to be flushed.

2. The method of claim 1, wherein the request specifies a physical address range to be flushed, the method further comprising:
issuing each command by the cache maintenance hardware engine to one or more of the clusters, with each command specifying one physical address in the physical address range.

3. The method of claim 1, wherein issuing the commands further comprises:
in response to a determination that a given physical address specified by a command is in a snoop filter, wherein the snoop filter is part of a cache coherent interconnect that connects the clusters to the memory, issuing the command to corresponding one or more clusters that have the cache line identified by the given physical address.

4. The method of claim 3, wherein issuing the commands further comprises:
receiving the commands from the cache maintenance hardware engine by the snoop filter; and
forwarding by the snoop filter only the commands that specify physical addresses stored in the snoop filter.

5. The method of claim 3, wherein issuing the commands further comprises:
receiving the commands from the cache maintenance hardware engine by multiple filter banks in the snoop filter, each filter bank responsible for a portion of physical address space of the memory; and
forwarding by the filter banks in parallel only the commands that specify physical addresses stored in the filter banks.

6. The method of claim 1, wherein issuing the commands further comprises:
accessing stored physical addresses in a snoop filter by the cache maintenance hardware engine, wherein the snoop filter is part of a cache coherent interconnect that connects the clusters to the memory; and
issuing a command specifying a stored physical address in the snoop filter in response to a determination that the stored physical address falls into a physical address range specified by the request.

7. The method of claim 1, wherein the request specifies a whole system flush, the method further comprising:
accessing stored physical addresses in the snoop filter by the cache maintenance hardware engine, wherein the snoop filter is part of a cache coherent interconnect that connects the clusters to the memory; and
issuing the commands to flush the cache contents identified by the stored physical addresses.

8. The method of claim 1, wherein the cache maintenance hardware engine is a co-processor of at least one of the processors and is located within at least one of the clusters.

9. The method of claim 1, wherein the cache maintenance hardware engine is part of a cache coherent interconnect.

10. The method of claim 1, wherein the cache maintenance hardware engine is coupled to a cache coherent interconnect via a same or a variation of an interface protocol used by the processors.

11. A system operative to flush cache contents, the system comprising:
a plurality of clusters, each cluster includes a plurality of processors and a plurality of caches;
a memory coupled to the clusters via a cache coherence interconnect; and
a cache maintenance hardware engine operative to:
receive a request from one of the processors to flush the cache contents to the memory;
generate commands to flush the cache contents to thereby remove workload of generating the commands from the processors; and
issue the commands or cause the command to be issued to the clusters, with each command specifying a physical address that identifies a cache line to be flushed.

12. The system of claim 11, wherein the request specifies a physical address range to be flushed, the cache maintenance hardware engine is further operative to:
issue each command to one or more of the clusters, with each command specifying one physical address in the physical address range.

13. The system of claim 11, further comprising:
a snoop filter, which is part of a cache coherent interconnect that connects the clusters to the memory, the snoop filter is operative to:
in response to a determination that a given physical address specified by a command is in the snoop filter, issue the command to corresponding one or more clusters that have the cache line identified by the given physical address.

14. The system of claim 13, wherein the snoop filter is further operative to:
receive the commands from the cache maintenance hardware engine; and
forward only the commands that specify physical addresses stored in the snoop filter.

15. The system of claim 13, wherein the snoop filter further includes multiple filter banks, and each filter bank is responsible for a portion of physical address space of the memory, the filter banks operative to:
receive the commands from the cache maintenance hardware engine; and
forward in parallel only the commands that specify physical addresses stored in the filter banks.

16. The system of claim 11, further comprising:
a snoop filter, which is part of a cache coherent interconnect that connects the clusters to the memory, wherein the cache maintenance hardware engine is further operative to:
access stored physical addresses in the snoop filter; and
issue a command specifying a stored physical address in the snoop filter in response to a determination that the stored physical address falls into a physical address range specified by the request.

17. The system of claim 11, further comprising:
a snoop filter, which is part of a cache coherent interconnect that connects the clusters to the memory, wherein the cache maintenance hardware engine is further operative to:
access stored physical addresses in the snoop filter; and
in response to the request that specifies a whole system flush, issue the commands to flush the cache contents identified by the stored physical addresses.

18. The system of claim 11, wherein the cache maintenance hardware engine is a co-processor of at least one of the processors and is located within at least one of the clusters.

19. The system of claim 11, wherein the cache maintenance hardware engine is part of a cache coherent interconnect.

20. The system of claim 11, wherein the cache maintenance hardware engine is coupled to a cache coherent interconnect via a same or a variation of an interface protocol used by the processors.
